(19) United States
(12) Patent Application Publication
(10) Pub. No.: US 2007/0018365 A1
(43) Pub. Date: Jan. 25, 2007

(54) Fountainhead and process of manufacturing the same

(76) Inventor: Angelo V. Pugliese, Vista, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/176,144

(22) Filed: Jul. 6, 2005

(51) Int. Cl. C04B 33/34

(52) U.S. Cl. 264/600

(57) ABSTRACT

The present invention provides a method for manufacturing fountainheads, as well as fountainheads made by the process that include non-circular and non-oval-shaped (e.g., square, triangular and rectangular) holes. The method of manufacturing involves a number of steps including the following: creating a design for the fountainhead; constructing at least two mold cavities based on the design; using the two cavities to form fountainhead pieces; and, combining the fountainhead pieces.

### FIELD OF THE INVENTION

The present invention provides a method for manufacturing fountainheads. It further provides fountainheads made by the process that include non-circular and non-oval-shaped (e.g., square, triangular and rectangular) holes.

### BACKGROUND OF THE INVENTION

Water features have become very popular in homeowner landscape design, both for their aesthetic and property improvement value. Though not limited to these specific areas, dynamic water features are currently being marketed in the spa, hot tub, pool, fountain and general landscaping fields.

The water features come in a variety of shapes, sizes, costs and complexities; they are typically built into the design of a system. The features use pumps and controls integrated into the system to operate. A fountainhead, in such designs, creates the visual look, pattern and sound. The features often cannot be changed or modified by the customer, because different water features require entire systems unique to each design. This creates a large number of parts and processes to control and service. One method of addressing these issues is to have a water feature that includes a user-interchangeable nozzle, jet or fountainhead.

One issue raised by the interchangeable fountainhead is how to effectively and efficiently manufacture it. A fountainhead typically works best with a length of straight flow or constant cross-section, which allows a cohesive stream to flow through and out of the head. The length of the fountain body is usually drilled or machined in the manufacturing process with the desired flow or spray pattern. Injection molding usually provides the least expensive part, however, the necessary mold complexity to pull hole pins at the various angles, would result in an expensive and delicate mold. A second alternative is to create a single generic part and employ a secondary operation to drill the desired hole pattern at the required angles. Both of these processes are expensive manufacturing options.

The present invention is directed to a process of manufacturing a fountainhead and to the fountainheads manufactured by the process.

### SUMMARY OF THE INVENTION

The present invention provides a method for manufacturing fountainheads. It further provides fountainheads made by the process that include non-circular and non-oval-shaped (e.g., square, triangular and rectangular) holes.

In a method aspect, the present invention provides a method of manufacturing a fountainhead. The method involves a number of steps including the following: creating a design for the fountainhead; constructing at least two mold cavities based on the design; using the two cavities to form fountainhead pieces; and, combining the fountainhead pieces. The fountainhead pieces typically include at least two channels that form non-circular and non-oval-shaped holes when they are combined. The holes are oftentimes square, triangular or rectangular in shape. In certain cases, channels of the fountainhead pieces run at different angles (i.e., they are not parallel to each other, or with respect to an axis of the fountainhead).

In an article of manufacture aspect, the present invention provides a fountainhead that is made by the method described above.

In another article of manufacture aspect, the present invention provides a fountainhead piece. The piece typically includes at least two rectilinear channels (i.e., bounded by straight rather than curved sections). The piece is capable of forming a fountainhead including non-circular or non-oval shaped holes (e.g., square, triangular or rectangular holes) when combined with a second fountainhead piece. The rectilinear channels of the fountainhead piece oftentimes run at different angles (i.e., are not parallel to each other or with respect to an axis of the piece).

In a business method aspect, the present invention provides a method of reducing the cost of manufacturing a fountainhead. The method involves a number of steps, including the following: creating a fountainhead design where the fountainhead has at least two square, triangular or rectangular holes; and, manufacturing the designed fountainhead from at least two fountainhead pieces. When the preceding method is employed, it typically provides a cost savings of at least ten, twenty, thirty or even forty percent as compared with manufacturing a fountainhead from a single piece.

In another article of manufacture aspect, the present invention provides a spa. The spa includes a fountainhead containing at least two non-circular or non-oval-shaped holes (e.g., square, triangular or rectangular holes) that provide for the spray of water, typically in different directions. Oftentimes, the fountainhead is formed from at least two fountainhead pieces including rectilinear channels, and the channels may run at different angles with respect to each other, and an axis of the fountainhead.

### BRIEF DESCRIPTION OF THE DRAWINGS

FIG. 1 shows a flow chart depicting a method of manufacturing a fountainhead according to the present invention.

FIG. 2 shows a topside view of one embodiment of the fountainhead of the present invention.

FIG. 3 shows a perspective view of one embodiment of a fountainhead piece of the present invention.

FIG. 4 shows a perspective view of another embodiment of a fountainhead piece of the present invention.

FIGS. 5, 6 and 7 show a second embodiment of the fountainhead formed of two pieces.

### DETAILED DESCRIPTION OF THE INVENTION

The present invention provides a method for manufacturing fountainheads. It further provides fountainheads made by the process that include non-circular and non-oval-shaped (e.g., square, triangular and rectangular) holes.

A fountainhead may be molded in two or more pieces using a simple open and close mold by using a non-circular or non-oval-shaped hole design (e.g., square, triangular or rectangular) for the spray pattern. The square or rectangular hole, for example, allows the stream-forming straight section of the fountainhead to be formed in each half of the molded part, at various angles both on the x- and y-axis. The use of the non-circular/non-oval-shaped hole eliminates the need for a further drilling step and allows for an easier mating of mold halves. The resulting, formed opening has a constant cross section, which provides a cohesive, shaped stream. Once the stream leaves the hole, the surface tension of the water reforms the stream into a traditional round-shaped stream.

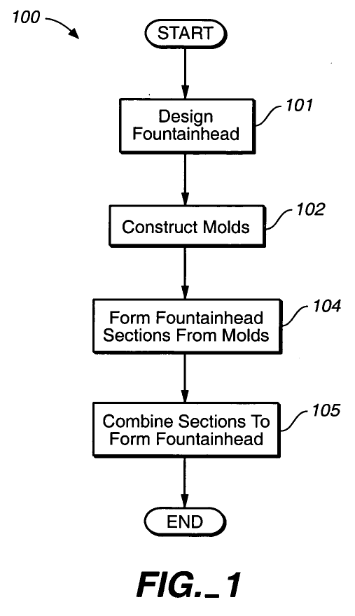

The method of the present invention is further illustrated in reference to FIG. 1, which shows a flow chart depicting a method of manufacturing a fountainhead (100). A fountainhead is designed in step 101. The design will typically include the overall shape and size of the fountainhead, as well as its spray pattern. In this case, the spray pattern will be defined in terms of non-circular/non-oval-shaped channels (e.g., square, triangular and/or rectangular channels) within the fountainhead. At least two mold cavities are then constructed (102), with each corresponding to a portion of the fountainhead (e.g., approximately one-half of the fountainhead) along the axis of water exit and entry. The fountainhead sections are formed from the cavities in step 104, and are subsequently combined (e.g., through a gluing operation, or other joining method) to provide the desired fountainhead (105).

The method of the present invention provides a significant economic advantage over other methods of fountainhead construction. For instance, the molds used will be about one-third to one-half the cost of a traditional, slide actuated mold. A simple gluing or joining operation will furthermore replace the expensive drilling of holes within the fountainhead at various angles. Both of the preceding cost-saving aspects will result in fountainhead manufacturing costs that are at least twenty percent less than typical manufacturing methods. Preferably, the costs will be thirty, forty, fifty, sixty or seventy percent less than such methods.

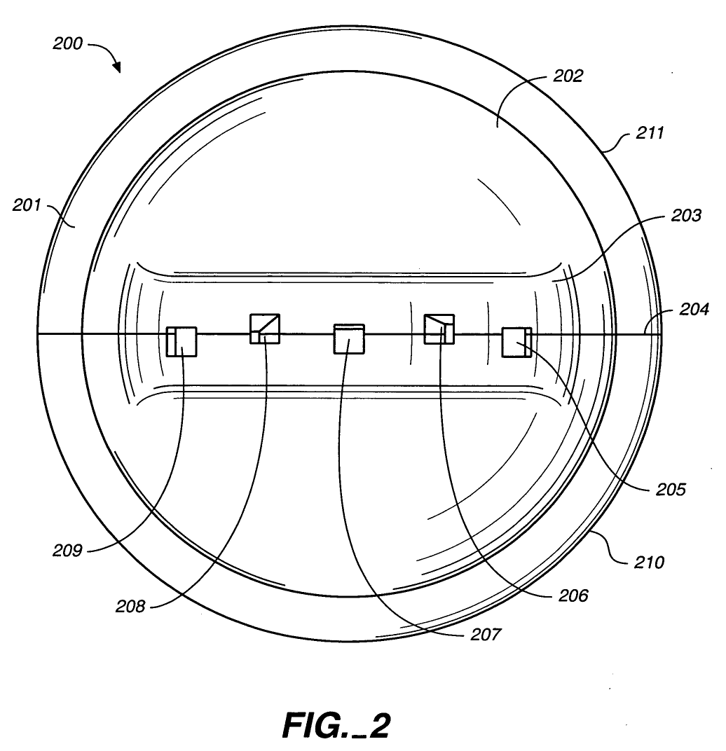

The fountainhead, or portion thereof, of the present invention is further illustrated in reference to FIGS. 2-7. FIG. 2 shows a topside view of one embodiment of a fountainhead (200). The fountainhead 200 as shown is circular, but any suitable shape is embraced by the present invention. Fountainhead 200 has an outer ledge 201, an inner raised portion 202 and a grooved portion 203, which includes spray outlets 205-209. As shown, each of the outlets 205-209 are cut at different angles with respect to each other and with respect to the top plane of the fountainhead. Line 204 is the point of combination for fountainhead 200, which serves to hold its two halves (210 and 211) together.

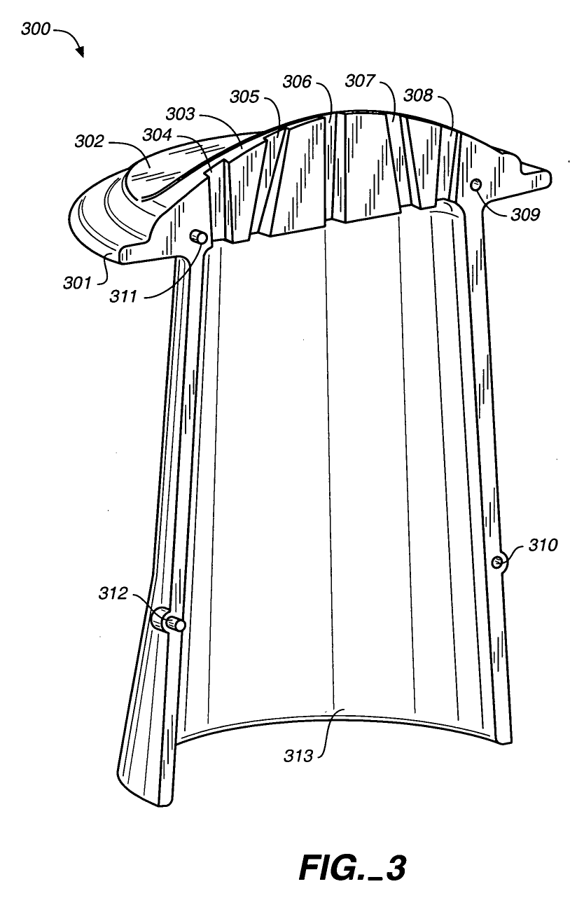

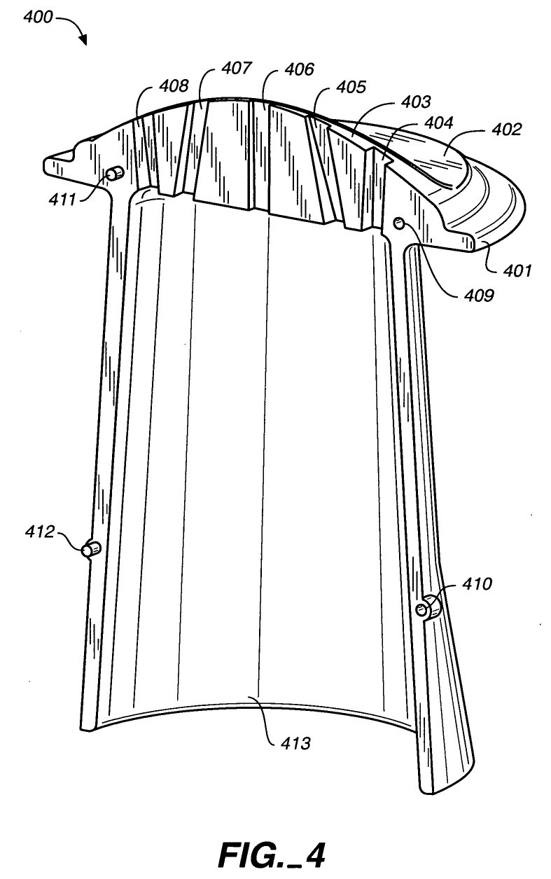

FIG. 3 shows a perspective view of one embodiment of a fountainhead piece 300 (also shown as 210 in FIG. 2) that forms fountainhead 200 when combined with a second fountainhead piece (i.e., 211 as shown in FIG. 2). Fountainhead piece 300 has an outer ledge 301, an inner raised portion 302, and a partial groove 303. Partial groove 303 includes channels 304-308, which are of different angles and depths. When combined with fountainhead piece 211 (also labeled as 400 in FIG. 4), channels 304-308 form spray outlets 205-209 of fountainhead 200. Pin holes 309 and 310 are formed to accept pins on another fountainhead piece, similar to pins 311 and 312, thereby guiding the combination of pieces and serving to strengthen the resulting fountainhead. As shown by this view, fountainhead piece 300 further includes a channel portion 313 through which, when fountainhead 200 is formed from 300, water is transported to the spray outlets.

FIG. 4 shows a perspective view of one embodiment of a fountainhead piece 400 (also shown as 211 in FIG. 2). Fountainhead piece 400 includes elements similar to fountainhead piece 300: outer edge 401; inner raised portion 402; partial groove 403; channels 404-408; pin holes 409 and 410; pins 411 and 412; and, channel portion 413. A primary difference between the elements of 400 and those of 300, however, is that those of 400 are of a complementary configuration to those of 300.

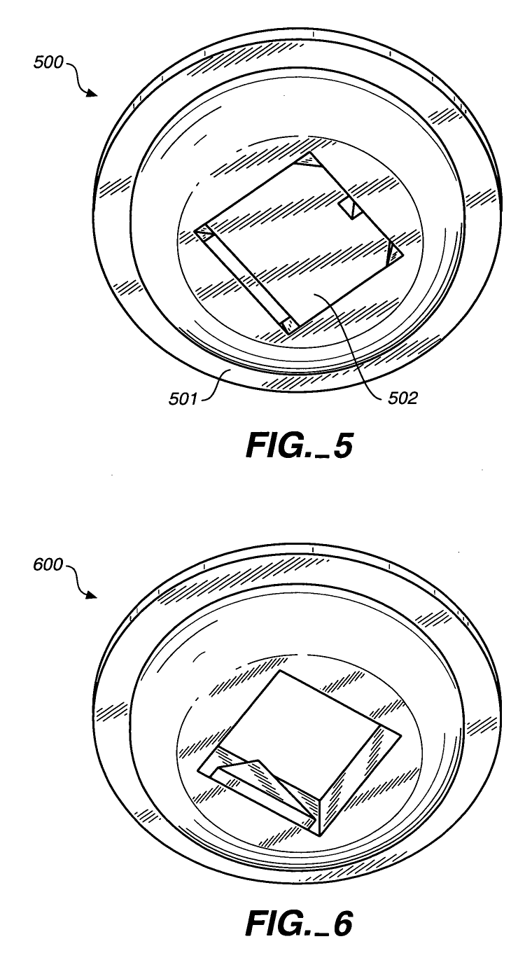

FIG. 5 shows another embodiment of the present invention (500). In this case, the combination of two pieces (501 and 502) form holes at different angles, allowing flexibility of the spray design.

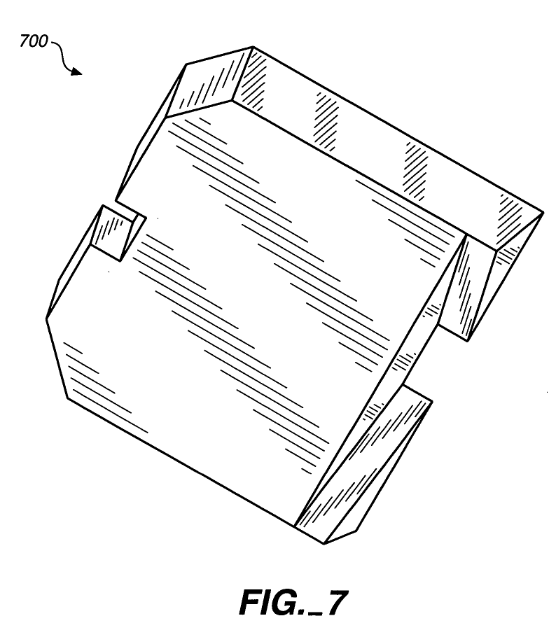

FIG. 6 shows the outer ring (600), which is shown as 501 in FIG. 5. The piece has flat sides and square corners, except for the one side that contains a v-shaped piece.

FIG. 7 shows inner piece (700), which is shown as 502 in FIG. 5. The piece contains grooves for fountain streams on the flat sides of the outer piece and a matching v-groove to form the stream with the v-groove on the outer ring.

The invention embodiments discussed above and shown in FIGS. 1-7 are presented only by way of example. Other embodiments of the invention may be within the scope of the following claims.

1. A method of manufacturing a fountainhead, wherein the method comprises:
a) creating a design for the fountainhead;
b) constructing at least two mold cavities based on the design;
c) using the two cavities to form fountainhead pieces; and,
d) combining the fountainhead pieces
thereby providing the fountainhead.

2. The method according to claim 1, wherein the fountainhead pieces comprise at least two channels that form non-circular and non-oval-shaped holes when they are combined.

3. The method according to claim 2, wherein the holes are square, triangular or rectangular in shape.

4. The method according to claim 2, wherein the at least two channels run at different angles with respect to an axis of the fountainhead.

5. The method according to claim 2, wherein at least one of the channels comprises a first segment and a second segment that run at different angles with respect to one another.

6. The method according to claim 3, wherein the at least two channels run at different angles with respect to an axis of the fountainhead, and wherein at least one of the channels comprises a first segment and a second segment that run at different angles with respect to one another.

7. A fountainhead that is manufactured by a method comprising:
a) creating a design for the fountainhead;
b) constructing at least two cavities based on the design;
c) using the two cavities to form fountainhead pieces; and,
d) combining the fountainhead pieces thereby providing the fountainhead.

8. The fountainhead according to claim 7, wherein the fountainhead pieces comprise at least two channels that form non-circular and non-oval-shaped holes when they are combined.

9. The fountainhead according to claim 8, wherein the holes are square, triangular or rectangular in shape.

10. The fountainhead according to claim 8, wherein the at least two channels run at different angles with respect to an axis of the fountainhead.

11. A fountainhead piece, wherein the piece comprises at least two rectilinear channels, and wherein the piece is capable of forming a fountainhead comprising square, triangular or rectangular holes when combined with a second fountainhead piece.

12. The fountainhead piece according to claim 11, wherein the at least two rectilinear channels run at different angles with respect to an axis of the fountainhead piece.

13. The fountainhead piece according to claim 11, wherein at least one of the channels comprises a first segment and a second segment that run at different angles with respect to one another.

14. A method of reducing the cost of manufacturing a fountainhead, wherein the method comprises:
a) creating a fountainhead design, wherein the fountainhead has at least two square, triangular or rectangular holes;
b) manufacturing the designed fountainhead from at least two fountainhead pieces thereby reducing the cost of manufacturing the fountainhead.

15. A spa comprising at least one fountainhead, wherein the fountainhead comprises at least two square, triangular or rectangular holes, and wherein the holes provide for the spray of water in different directions.

16. The spa according to claim 15, wherein the fountainhead is formed from at least two fountainhead pieces comprising at least two rectilinear channels.

17. The spa according to claim 16, wherein the at least two rectilinear channels run at different angles with respect to an axis of the fountainhead.
